(19) United States
(12) Patent Application Publication
(10) Pub. No.: US 2012/0220810 A1
(43) Pub. Date: Aug. 30, 2012

(54) Method for optimal paint residue stabilization

(76) Inventor: Keith Edward Forrester, Meredith, NH (US)

(21) Appl. No.: 13/385,304

(22) Filed: Feb. 13, 2012

Related U.S. Application Data
(60) Provisional application No. 61/463,308, filed on Feb. 15, 2011.

(51) Int. Cl. A62D 3/00

(52) U.S. Cl. 588/315

(57) ABSTRACT

This invention provides an optimal method for stabilization of heavy metal bearing paint residue subject to acid and water leaching tests or leach conditions by addition of environmental safe, worker safe, and multi-media compatible stabilizing agents to the blast media, thus allowing for paint residue stabilization outside of or within an OSHA containment building or collection device, such that leaching of heavy metals such as lead are inhibited to desired levels. The resultant stabilized paint residue and spent blast media mixture is suitable for on-site reuse, off-site reuse, or disposal as RCRA non-hazardous waste.

### BACKGROUND OF THE INVENTION

Heavy metal bearing paint residue, and mixtures of heavy metal bearing paint residue and spent paint removal blasting or abrasive media, may be deemed “Hazardous Waste” by the United States Environmental Protection Agency (USEPA) pursuant to 40 C.F.R. Part 261 and also deemed hazardous under similar regulations in other countries such as Japan, Switzerland, Germany, United Kingdom, Mexico, Australia, Canada, Taiwan, European Countries, India, and China, and deemed special waste within specific regions or states within those countries, if containing designated leachate solution-soluble and/or sub-micron filter-passing particle sized heavy metals such as; Arsenic (As), Silver (Ag), Barium (Ba), Lead (Pb), Cadmium (Cd), Chromium (Cr), Mercury (Hg), Selenium (Se), Copper (Cu), Zinc (Zn), and Antimony (Sb), above levels deemed hazardous by those country, regional or state regulators.

In the United States, any solid waste can be defined as Hazardous Waste either because it is “listed” in 40 C.F.R., Part 261 Subpart D, federal regulations adopted pursuant to the Resource Conservation and Recovery Act (RCRA), or because it exhibits one or more of the characteristics of a Hazardous Waste as defined in 40 C.F.R. Part 261, Subpart C. The hazard characteristics defined under 40 CFR Part 261 are: (1) ignitability, (2) corrosivity, (3) reactivity, and (4) toxicity as tested under the Toxicity Characteristic Leaching Procedure (TCLP). 40 C.F.R., Part 261.24(a), contains a list of heavy metals and their associated maximum allowable concentrations, as measured under the USEPA Method 1311 leach test, TCLP. If a heavy metal, such as lead, exceeds its maximum levels from the solid waste at levels above the maximum allowable concentrations prior to placement in a surface impoundment, waste pile, landfill or other land disposal unit as defined in 40 C.F.R. 260.10.

Suitable acetic acid leach tests include the USEPA SW-846 Manual described Toxicity Characteristic Leaching Procedure (TCLP) and Extraction Procedure Toxicity Test (EP Tox) now used in all Provinces of Canada except Quebec. Briefly, in a TCLP test, 100 grams of waste are tumbled with 2000 ml of dilute and buffered or non-buffered acetic acid for 18 hours and then filtered through a 0.75 micron filter prior to nitric acid digestion and final ICP analyses for total “soluble” metals. The extract solution is made up from 5.7 ml of glacial acetic acid and 64.3 ml of 1.0 normal sodium hydroxide up to 1000 ml dilution with reagent DI water.

Suitable DI carbonated water leach tests include the Japanese leach test which tumbles 50 grams of composited waste sample in 500 ml of water for 6 hours held at pH 5.8 to 6.3, followed by centrifuge and 0.45 micron filtration prior to analyses. Another suitable distilled water CO₂ saturated method is the Swiss protocol using 100 grams of cemented waste at 1 cm³ in two (2) sequential water baths of 2000 ml. The concentration of lead and salts are measured for each bath and averaged together before comparison to the Swiss criteria.

Suitable citric acid leach tests include the California Waste Extraction Test (WET), which is described in Title 22, Section 66700, “Environmental Health” of the California Health & Safety Code. Briefly, in a WET test, 50 grams of waste are tumbled in a 1000 ml tumbler with 500 grams of sodium citrate solution for a period of 48 hours. The concentration of leached lead is then analyzed by Inductively-Coupled Plasma (ICP) after filtration of a 100 ml aliquot from the tumbler through a 45 micron glass bead filter.

The present invention provides an optimal method of reducing the solubility of heavy metal bearing paint residue and mixed spent blast media. Paint residue heavy metal solubility is controlled by the invention as measured under TCLP, SPLP, CALWET, MEP, rainwater and surface water leaching conditions as well as under regulatory water extraction test conditions as defined by waste control regulations in Thailand, Taiwan, Japan, Canada, UK, Mexico, Switzerland, Germany, Sweden, The Netherlands and under American Nuclear Standards for sequential leaching of wastes by de-ionized water.

Unlike the present invention, prior art has focused on reducing solubility of heavy metals, mostly lead, from paint residues by application of phosphate sources blended with Latex [paint and silicates onto surfaces prior to blasting (Forrester U.S. Pat. No. 6,515,053 B1), application of a narrow field of phosphates blended with blast media used for painted surface removal by air blasting (Forrester U.S. Pat. No. 6,186,939 B1), and post-paint removal blasting application of known heavy metal stabilizers such as phosphates, carbonates, cement, silicates, with or without mineral complexers, in accumulation tanks or waste piles after collection or accumulation of the paint residue (Forrester U.S. Pat. No. 5,846,178, Forrester U.S. Pat. No. 5,722,928 and Forrester U.S. Pat. No. 5,536,899 and cited art from those applications). Previous invented methods failed to recognize the importance of applying a blended mixture of paint removal media and paint residue stabilizer with or without mineral complexing agents that are (1) engineered to be safe to the environment and biological communities either outside of or inside the painted structure OSHA containment building, worker-safe regarding inhalation-ingestion-dermal contact, non-toxic, compatible with painted surface substrate, and (2) which are multi-media compatible and thus suitable for blending with dry blasting media, semi-wet sponge blast media, and high pressure water paint blast systems. The subject pre-mixed stabilizer and media method allows for stabilized paint residue and spent paint removal media production and handling either outside of or within the paint residue OSHA enclosure after residue removal from the structure and/or within devices used to collect residue from the OSHA container and before the discharge of the residues into accumulation containers.

The preferred and least expensive paint stabilizer for lead (the most predominant source of regulated paint residues) would be calcium phosphate sources such as monocalcium phosphate, single superphosphate, triple superphosphate, dicalcium phosphate, dicalcium phosphate dihydrate powder, monocalcium phosphate, and tricalcium phosphate for substitution of Pb into calcium phosphate apatite mineral(s). It has been found that the calcium phosphates monodicalcium phosphate in deflorinated feed form, and dicalcium phosphate dihydrate powder, can also stabilize chromium and arsenic. Dicalcium phosphate dihydrate powder is of specific value as a stabilizer, as it is extremely safe (being a food grade chemical and used in toothpaste and pills worldwide), as well as being in a form of powder which has highly active surface sites for lead and heavy metal ion-exchange and precipitation, as well as a physical composition and form that allows for excellent uniform and steady-state blending and non-sifting during handling and shipping after blending. These calcium phosphate stabilizer additives also have the extremely unique capability to be applied as a dry powder, dry granular, or fine colloidal slurry mixture additive that will easily remain suspended in solution and convey uniformly with pressurized pots and media venturi pickup blast methods, given that the water solubility of calcium phosphates are very low and thus avoid wetted media exothermic curing as would happen with wetting or semi-wetting of alternate vendor technologies such as Blastox® calcium silicates and calcium oxides, both of which are highly water soluble and highly hydroscopic and reactive. The most significant advantage with production of lead substituted calcium phosphate minerals in paint residue is that the solubility constant, and hence leachability and bioavailability, are greatly reduced in this true apatite form at Ksp 10E-92, as compared to the simple lead-silicate and lead-oxide minerals forms at Ksp values greater than 10E-5 from Blastox® type amended solid media.

U.S. Pat. No. 5,202,033 describes an in-situ method for decreasing Pb TCLP leaching from solid waste using a combination of solid waste additives and additional pH controlling agents from the source of phosphate, carbonate, and sulfates.

U.S. Pat. No. 5,037,479 discloses a method for treating highly hazardous waste containing unacceptable levels of TCLP Pb such as lead by mixing the solid waste with a buffering agent selected from the group consisting of magnesium oxide, magnesium hydroxide, reactive calcium carbonates and reactive magnesium carbonates with an additional agent which is either an acid or salt containing an anion from the group consisting of Triple Superphosphate (TSP), ammonium phosphate, diammonium phosphate, phosphoric acid, boric acid and metallic iron.

U.S. Pat. No. 4,889,640 discloses a method and mixture from treating TCLP hazardous lead by mixing the solid waste with an agent selected from the group consisting of reactive calcium carbonate, reactive magnesium carbonate and reactive calcium magnesium carbonate.

U.S. Pat. No. 4,652,381 discloses a process for treating industrial wastewater contaminated with battery plant waste, such as sulfuric acid and heavy metals by treating the waste waster with calcium carbonate, calcium sulfate, calcium hydroxide to complete a separation of the heavy metals.

### SUMMARY OF THE INVENTION

The present invention discloses a heavy metal bearing mixed paint residue and spent paint removal media solubility reduction method by contact of heavy metal bearing paint with a pre-blend of blast removal media and optimal engineered heavy metal stabilizers. The stabilizers are specifically engineered and improved over existing pre-blended stabilizers and blast media, given that this new pre-blended media and stabilizer method uses only environmental-safe, worker-safe, non-toxic, substrate compatible, and multi-media compatible stabilizers, suitable for blending with dry blasting media, semi-wet sponge blast media, and high pressure water paint blast systems. It has been observed by the inventor that current heavy metal control and abatement systems used worldwide at paint removal projects are not capable of collecting 100% of the newly generated stabilizer and paint blend, and thus the existing technologies are lacking in production of environmental and worker exposure safe resultant minerals and molecules that are also capable of being used with the dry and wet abrasive removal techniques used by paint removal and collection contractors.

The preferred stabilizer for lead bearing paint and spent media is calcium phosphate sources such as single superphosphate, triple superphosphate, dicalcium phosphate, dicalcium phosphate dihydrate powder, monocalcium phosphate, and tricalcium phosphate for substitution of Pb into calcium phosphate apatite mineral(s).

### DETAILED DESCRIPTION

Environmental regulations throughout the world such as USEPA regulations written under RCRA and CERCLA mandate, require heavy metal bearing waste, heavy metal bearing contaminated soils and materials producers to manage such materials and wastes in a manner safe to the environment and protective of human health. In response to these regulations, environmental engineers and scientists have developed numerous means to control heavy metals, mostly through chemical applications which convert the solubility of the material and waste character to a less soluble form, thus passing leach tests and allowing the wastes to be either reused on-site or disposed at local landfills without further and more expensive control means such as hazardous waste disposal landfills or regional TSDF facilities designed to provide metals stabilization. The primary focus of scientists has been on reducing solubility of heavy metals such as lead, cadmium, chromium, arsenic and mercury, as these were and continue to be the most significant mass of metals contamination in soils. Materials such as paint residues, cleanup site wastes such as battery acids and slag wastes from smelters and incinerators are major lead sources.

There exists a demand for improved and less costly control methods of heavy metals from paint residue removal and recovery projects that allows for stabilization of heavy metals in paint residue and spent blast media into non-hazardous waste or materials that are stable, environmental-safe, worker-safe, non-toxic, substrate compatible, and multi-media compatible, and suitable for blending with dry blasting media, semi-wet sponge blast media, and high pressure water paint blast systems. The subject method allows for stabilized paint residue and spent media production and handling either outside of or within the paint residue OSHA enclosure after residue removal from the structure and/or within devices used to collect residue from the OSHA container and before the discharge of the residues into accumulation containers.

The preferred and least expensive paint stabilizer for lead (the most predominant source of regulated paint residues) would be calcium phosphate sources such as single superphosphate, triple superphosphate, dicalcium phosphate, dicalcium phosphate dihydrate powder, monocalcium phosphate, and tricalcium phosphate for substitution of Pb into calcium phosphate apatite mineral(s). It has been found that the calcium phosphates monodicalcium phosphate deflorinated feed form, and dicalcium phosphate dihydrate powder, can also stabilize chromium and arsenic. Dicalcium phosphate dihydrate powder is of specific value as a stabilizer, as it is extremely safe (being recognized as a food grade chemical and commonly used in toothpaste and pills worldwide), as well as being in a form of powder which has highly active surface sites for lead and heavy metal ion-exchange and precipitation, as well as a physical composition and form that allows for excellent uniform and steady-state blending and non-sifting after blending. These calcium phosphate stabilizer additives also have the extremely unique capability to be applied as a dry powder, dry granular, or slurry mixture additive that will easily suspend in solution and travel uniformly with pressurized pots and media venturi pickup blast methods, given that the water solubility of calcium phosphates are very low and thus avoid wetted media exothermic curing as would happen with wetting or semi-wetting of alternate vendor methods such as Blastox® generated calcium silicates and calcium oxides, both of which are highly water soluble and highly hydroscopic and reactive. The most significant advantage with production of lead substituted calcium phosphate minerals in paint residue is that the solubility constant, and hence leachability and bioavailability, are greatly reduced in this true apatite form at Ksp 10E-92, as compared to the simple lead-silicate and lead-oxide minerals forms at Ksp values greater than 10E-5 from alternate vendor methods such as Blastox® amended solid media.

The stabilizer agent selection, powder or granular size, dose rate applied with the blasting media (such as garnet, black beauty, slag, shell, water), and stabilizer to media blending method (such as ball mill, cone blending, tumbling, slurry cycling) can be engineered for each type of paint residue composition and environment anticipated, such as lead, chromium, arsenic, copper, zinc or combinations in paint residues produced.

Although the exact stabilization mineral formations are undetermined at this time, it is expected that when heavy metals in paint residue such as lead come into contact with the stabilizing agent and blended media with sufficient reaction time and energy, low soluble apatite minerals forms such as a Pb, Cr and As substituted hydroxyapatites, through substitution or surface bonding, will form at the point of media and stabilizer contact with paint surfaces, which are less soluble than the heavy metal element or molecule originally in the paint residue. There exist several thousand possible mineral low-solubility combinations possibly formed given the paint residue composition and possible stabilizer additives identified. Certain stabilizers may provide for long-term stabilization and passage of leach tests beyond that regulated, and thus be more suited to paint residues intended for reuse or land application. The stabilization design engineer is thus provided a multitude of stabilizer options which can be tested for final recipe solubility under the various leach tests of interest.

Although the calcium phosphates including monocalcium phosphate, single superphosphate, ordinary superphosphate, triple superphosphate, dicalcium phosphate, dicalcium phosphate dihydrate powder, and tricalcium phosphate are the preferred embodiments, examples of possible additional or separate suitable stabilizing and/or complexing agents include, but are not limited to, chlorides, iron, aluminum, ferric and ferrous sulfates, aluminum sulfate, flocculants, coagulants, nuclei particulates, ligands, cement kiln dust, lime kiln dust, sulfides, iron, silicates, phosphate fertilizers, phosphate rock, pulverized phosphate rock, calcium orthophosphates, trisodium phosphates, calcium oxide (quicklime), dolomitic quicklime, natural phosphates, phosphoric acids, dry process technical grade phosphoric acid, wet process green phosphoric acid, wet process amber phosphoric acid, black phosphoric acid, merchant grade phosphoric acid, aluminum finishing phosphoric and sulfuric acid solution, hypophosphoric acid, metaphosphoric acid, hexametaphosphate, tertrapotassium polyphosphate, polyphosphates, trisodium phosphates, pyrophosphoric acid, fishbone phosphate, animal bone phosphate, herring meal, bone meal, phosphorites, and combinations thereof. Salts of phosphoric acid can be used and are preferably alkali metal salts such as, but not limited to, trisodium phosphate, dicalcium phosphate, disodium hydrogen phosphate, sodium dihydrogen phosphate, tripotassium phosphate, dipotassium hydrogen phosphate, potassium dihydrogen phosphate, trilithium phosphate, dilithium hydrogen phosphate, lithium dihydrogen phosphate or mixtures thereof.

The amounts of stabilizing agent and possible additional agent(s) and complexing additive combinations used, according to the method of invention, depend on various factors including desired solubility reduction potential (such as less than 5.0 ppm or 0.75 ppm TCLP Pb as required under 40 CFR Part 261.24 or 40 CFR part 268 LDR disposal limitation for land disposed stabilized paint residue and media mixtures), desired mineral toxicity (such as less than 50% lethal dose when exposed to a batch aquatic toxicity test using fathead minnows under the WADOE toxicity regulations), and desired mineral formation relating to toxicological and site environmental control objectives (such as lead pyromorphites, chloropyromorphite, corkite, plumbogummite). It has been found that a pre-blend mixture of 2% dicalcium phosphate dihydrate powder or 2% single superphosphate by weight of media mixture, was sufficient for TCLP Pb stabilization of a media+stabilizer+residue waste composite to less than RCRA 5.0 ppm limit. However, the foregoing is not intended to preclude yet higher or lower pre-blend dose of stabilizing agent(s) or combinations of stabilizers and complexing agents.

The examples below are merely illustrative of this invention and are not intended to limit it thereby in any way.

### EXAMPLE 1

An elevated water storage tank exterior surface aged and weathered lead bearing paint was removed from a series of test areas with a combination of nozzle directed compressed air and pot Black Beauty blast media pre-blended (in a end-over-end tumbling blender) with various doses of Single Superphosphate (SSP), Dicalcium Phosphate Dihydrate Powder (DCPDHP), and Tricalcium Phosphate (TCP), and subjected to TCLP extraction by USEPA Method 1311 and extract Pb analyses by USEPA Method 200.7. The test areas were thereafter primed and painted along with the majority of the structural area which was blasted with traditional black beauty without added stabilizer(s). The test areas have not shown any adverse or variant substrate primer or painted surface adhesion, curing or weathering, as compared to the traditional non-stabilizer blended Black Beauty abrasive paint removal, primed and repainted area.

TABLE 1

| Stabilizer Addition | TCLP Pb (ppm) |
|---|---|
| Baseline | 49.00 |
| 2% SSP | <0.05 |
| 1% SSP | 2.42 |
| 2% DCPDHP | <0.05 |
| 1% DCPDHP | 2.61 |
| 2% TCP | <0.05 |
| 1% TCP | 3.02 |

### EXAMPLE 2

Plastic bead blast media and pre-blended stabilizer was used to remove paint residue containing cadmium and chromium from a military plane, and resulted in a stabilized blast media-to-residue ratio of approximately 50:1. The plastic media was dosed at various levels with various stabilizers including DCPDHP and TCP, and subjected to TCLP analyses. The plane surface was not repainted during the time of the pilot demonstration test due to US Air Force security protocol.

TABLE 2

| Stabilizer Addition | TCLP Cd—Cr (ppm) |
|---|---|
| Baseline | 5-23 |
| 2% DCPDHP | 0.52-3.7 |
| 2% TCP | 0.42-3.87 |

The foregoing results in Example 1 and 2 readily established the operability of the present process to stabilize heavy metals thus reducing leachability and bioavailability. Given the effectiveness of the blended blast media and stabilizing agent in causing lead and heavy metals from paint residues to stabilize as presented in the Table 1 and 2, it is believed that an amount of the pre-blended stabilizing agent doses equivalent to less than 2% by weight of blast media weight should be effective for most heavy metal bearing waste paint residue solubility reduction needs.

While this invention has been particularly shown and described with reference to preferred embodiments thereof, it will be understood by those skilled in the art that various changes in form and details may be made therein without departing from the spirit and scope of the invention as defined by the appended claims.

I claim:

1. A method of reducing the solubility of mixed heavy metal bearing paint residue and spent paint removal media, comprising contacting the mixed paint residue and spent paint removal media with at least one stabilizing agent in an amount effective in reducing the leaching of heavy metal to a level no more than non-hazardous levels as determined in an EPA TCLP test, performed on the stabilized material or waste, as set forth in the Federal Register, vol. 55, no. 126, pp. 26985-26998 (Jun. 29, 1990), while also meeting additional heavy metal removal project environmental and worker suitability criteria.

2. The method of claim 1, wherein the stabilizing agent(s) are selected from the group consisting of calcium phosphates, Portland Cement, cement kiln dust, lime kiln dust, lime, silicates, sulfides, iron, quicklime, phosphate complexers chlorides, iron and/or aluminum; wet process amber phosphoric acid, wet process green phosphoric acid, coproduct phosphoric acid solution from aluminum polishing, technical grade phosphoric acid, hexametaphosphate, polyphosphate, calcium orthophosphate, superphosphates, triple superphosphates, single superphosphate, ordinary superphosphates, crop production phosphates, phosphate fertilizers, phosphate rock, bone phosphate, fishbone phosphates, tetrapotassium polyphosphate, monocalcium phosphate, monoammonia phosphate, diammonium phosphate, dicalcium phosphate, dicalcium phosphate dihydrate powder, tricalcium phosphate, trisodium phosphate, salts of phosphoric acid, and combinations thereof.

3. A method of claim 1 wherein the stabilizers are applied to the mixed paint residues and removal media within an OSHA containment structure.

4. A method of claim 1 wherein the stabilizers are applied to the mixed paint residues and removal media within a collection device.

5. A method of claim 1 wherein the stabilizers are contacted with the mixed paint residue and removal media within a collection device prior to the device exhaust air filtration cyclone or baghouse.

6. A method of claim 1 wherein the stabilizers are contacted with the mixed paint residue and removal media within a vacuum collection device after the device exhaust air filtration cyclone or baghouse and before the discharge of the paint residue to an accumulation tank.

7. A method of claim 1 wherein the stabilizers are contacted with the mixed paint residue and removal media within a vacuum collection device after the device exhaust air filtration cyclone or baghouse and during the discharge of the mixed paint residue and removal media to an accumulation tank.

8. A method of claim 1 where the heavy metal stabilizer is pre-mixed with the heavy metal bearing paint removal (solid, semi-solid, or water blasting) media prior to contact with the paint residue.

9. A method of claim 1 where the paint removal media is solid abrasive, semi-wet sponge material, or water.

10. A method of claim 1 wherein reduction of solubility is to a level no more than non-hazardous levels as determined under leach tests required by regulation in countries other than the USA including but not limited to Switzerland, UK, Mexico, Taiwan, Japan, Thailand, China, Canada, Germany.

11. A method of claim 2 wherein the stabilizer(s) and complexing agents are selected to allow for formation of low toxicity and low solubility solid phase mineral, from the paint residue and removal media mixture available heavy metals and introduced stabilizers and removal media matrix, such as Lead Phosphate, Lead Chloropyromorphite, Lead Corkite, Lead Plumbogummite, Lead Sulfide, Lead Carbonate, Ferric Arsenate, and Trivalent Chromium Hydroxide.

12. A method of claim 2 wherein the heavy metal stabilizers selected allow for generation of heavy metal minerals at available paint residue surfaces which have low water and simulated rainwater extract solubility and resist leaching under SPLP leaching test USEPA method 1310.

13. A method of claim 2 wherein the heavy metal stabilizers selected allow for production of a post paint removal process substrate that is compatible with sequential application of paint surface cleaners, primers and paints.

14. A method of claim 2 wherein the heavy metal stabilizers selected provide for production of stabilized heavy metal bearing particulate, stabilized heavy metal contaminated residue, stabilizer contacted media, stabilizer contacted substrates, and residual airborne or deposited stabilizer chemicals, that are safe to workers upon various individual or combination exposures including dermal contact, inhalation, ingestion, and project synergistic exposures.

15. A method of claim 2 wherein the heavy metal stabilizers selected provide for production of stabilized heavy metal bearing particulate, stabilized heavy metal contaminated residue, stabilizer contacted media, stabilizer contacted substrates, and residual airborne or deposited stabilizer chemicals, that are safe to the project direct and adjacent environments and biological communities. The resultant mixed stabilizer, paint residue, and spent media, should not cause or contribute to adverse exposures in airspace, surface and ground waters, and grounds, thus avoiding production of conditions that could be corrosive, caustic, pH adverse (pH above 10.0 or below 6.5), or other site specific conditions determined to be adverse or detrimental to all potential environmental receptors.
